(19) United States
(12) Patent Application Publication
(10) Pub. No.: US 2007/0145225 A1
(43) Pub. Date: Jun. 28, 2007

(54) Land auger

(76) Inventor: David Edward Bondy, Amherstburg (CA)

Correspondence Address: DYKEMA GOSSETT PLLC, 39577 WOODWARD AVENUE, SUITE 300, BLOOMFIELD HILLS, MI, 48304-5086, US

(21) Appl. No.: 11/315,603

(22) Filed: Dec. 22, 2005

(51) Int. Cl. F16M 13/00

(52) U.S. Cl. 248/530

(57) ABSTRACT

An improved portable support for insertion into the ground is provided that more efficiently penetrates the ground, increases the depth to which the support may be inserted into the ground, improves the strength and support of the invention, decreases the amount of earth that must be displaced during insertion of the invention into the ground, and stabilizes the invention by allowing earth to flow up into the support during insertion of the support into the ground. The portable support includes a tube with an open end and an open coil. A first end of the coil is coupled to the open end of the tube, and a second end of the coil is configured for insertion into the ground. The coil is shaped so that a diameter of the first end of the coil is greater than a diameter of the second end of the coil.

### BACKGROUND OF THE INVENTION

1. Field of the Invention

This invention relates to ground-inserted support devices and, in particular, to a portable support device with an open tapered coil for insertion into the ground.

2. Discussion of Related Art

Support devices may be used to support various pieces of outdoor equipment, such as, but not limited to, umbrellas, lawn torches, flag poles, lawn ornaments, hanging plants, signs, volleyball nets, bird feeders, and bird houses. Support devices may also be used to tie down various objects, such as, but not limited to tents, pets, and guide wires. Support devices may further be used as land aircraft tie downs. Support devices must be insertable into different types of ground, including sand, lawn, and hard pack clay soil of varying degrees. Once inserted, support devices must be able to withstand the elements, including high wind gusts, in order to maintain the support device in an upright position.

Various support devices are disclosed in the prior art. In one type of these conventional support devices, the end of the device configured for insertion into the ground may be tapered. However, devices with tapered ends for ground-insertion, including the tapered end and the pipe or tube to which the tapered end is coupled, are generally closed. Such a closed design increases the amount of earth that must be displaced during insertion of the support device into the ground. In another type of conventional support devices, the end of the device configured for insertion into the ground may be open. The tube, to which the end of the portion of the device for insertion into the ground is coupled, may also be open. However, devices with an open tube end or open end for insertion into the ground are generally of uniform diameter (i.e., cylindrical), which shape has not been entirely satisfactory in penetrating the ground.

The inventor herein has recognized a need for a support device that will minimize and/or eliminate one or more of the above-identified deficiencies.

### SUMMARY OF THE INVENTION

The present invention provides a portable support for insertion into the ground.

A portable support in accordance with the present invention includes a tube with an open end and an open coil. The first end of the open coil is coupled to the end of the tube. The second end of the open coil is configured for insertion into the ground. The coil is shaped so that a diameter of the first end of the coil is greater than a diameter of the second end of the coil. In one embodiment, the coil is in a tapered shape, although other shapes where the second, distal end is reduced in diameter are possible and yet remain within the spirit and scope of the present invention.

A portable support in accordance with the present invention is a significant improvement over conventional ground-inserted support devices. First, the tapered end of the coil of the portable support more efficiently penetrates the ground and increases the depth to which the portable support may be inserted into the ground for improved support and strength (i.e., increased withdrawal force required to pull straight out). Second, the coil is open to thereby decrease the amount of earth that is displaced during insertion of the portable support into the ground. Third, a bottom end of the tube is open in order to both decrease the amount of earth that is displaced during insertion of the portable support into the ground and further to stabilize the portable support by allowing earth to flow up into the pipe during insertion of the portable support into the ground. Fourth, the inventive support is relatively lightweight and of small size, increasing the portability of the support device.

These and other advantages of this invention will become apparent to one skilled in the art from the following detailed description and the accompanying drawings illustrating features of this invention by way of example.

### BRIEF DESCRIPTION OF THE DRAWINGS

FIG. 1 is a perspective view of a portable support in accordance with the present invention.

FIG. 2 is a perspective view of the portable support of FIG. 1 inserted into the ground.

FIG. 3 is a perspective view of the portable support of FIGS. 1-2 inserted into the ground.

FIG. 4 is a cross-sectional view of the coil of the portable support of FIGS. 1-3.

FIG. 5 is a perspective view of a portable support in accordance with another embodiment of the present invention.

### DETAILED DESCRIPTION OF EMBODIMENTS OF THE INVENTION

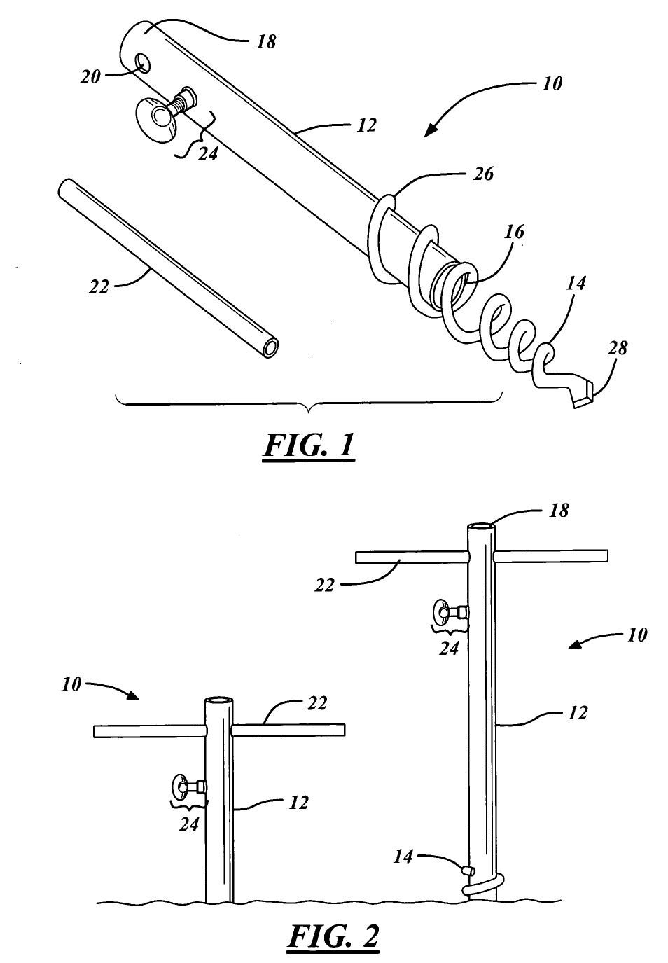

Referring now to the drawings wherein like reference numerals are used to identify identical components in the various views, FIGS. 1-3 illustrate a portable support 10 in accordance with the present invention. Support 10 is configured for manual insertion into the ground to a sufficient depth to support a piece of equipment or to serve as a point of attachment for any of various tethered objects. In accordance with the present invention, support 10 includes a tube 12 and a coil 14.

Tube 12 is configured to house and support a piece of equipment or to serve as a point of attachment for any of various tethered objects. In an exemplary embodiment, tube 12 is generally cylindrical in shape, thin-walled in construction to form a hollow interior, and may comprise steel. Tube 12 may be approximately 22″ (559 mm) long and approximately 1¾″ (44 mm) in diameter. In other exemplary embodiments, tube 12 may be shorter or longer or may be smaller or greater in diameter to accommodate various sizes of equipment or various tethered objects. For example, in other exemplary embodiments, tube 12 may be approximately 2″ (51 mm) or approximately 2½″ (64 mm) in diameter to accommodate larger pieces of equipment. It is understood that while these dimensions are described in detail, one of ordinary skill in the art may alter the dimensions of tube 12 and remain within the spirit and scope of the invention. Tube 12 includes a first bottom end 16 and a second top end 18 axially opposite the first end 16.

Bottom end 16 is open to the hollow interior described above, providing access thereto. During insertion, the opening allows entry of earth for decreasing the amount of earth that must be displaced into the adjacent ground. In addition, the opening provides stabilizing support 10 by allowing earth to flow up into tube 12 during insertion of support 10 into the ground.

Top end 18 may include aligned and diametrically opposite apertures 20 near top end 18. Apertures 20 are configured to receive a handle 22. In an exemplary embodiment, apertures 20 may be approximately ¾″ (19 mm) in diameter. It is understood that while this dimension is described in detail, one of ordinary skill in the art may alter the dimension of apertures 20 and remain within the spirit and scope of the invention. Additional aligned and diametrically opposite apertures may also be located at various points along the axial length of tube 12.

Handle 22 is configured for manually turning and twisting support 10 into the ground to a sufficient depth. Handle 22 is configured to be insertable into apertures 20 during insertion of support 10 into the ground and to also be removable and stowable within tube 12 when support 10 is not being turned and inserted. Handle 22 may comprise a steel tube. Handle 22 may be approximately 16″ (406 mm) long and approximately ¾″ (19 mm) in diameter. It is understood that while these dimensions are described in detail, one of ordinary skill in the art may alter the dimensions of handle 22 and remain within the spirit and scope of the invention. The diameter of handle 22 may be smaller than the diameter of tube 12 and the length of handle 22 may be shorter than the length of tube 12, so that handle 22 may be stored within tube 12 when support 10 is being transported, thereby adding to the portability of support 10.

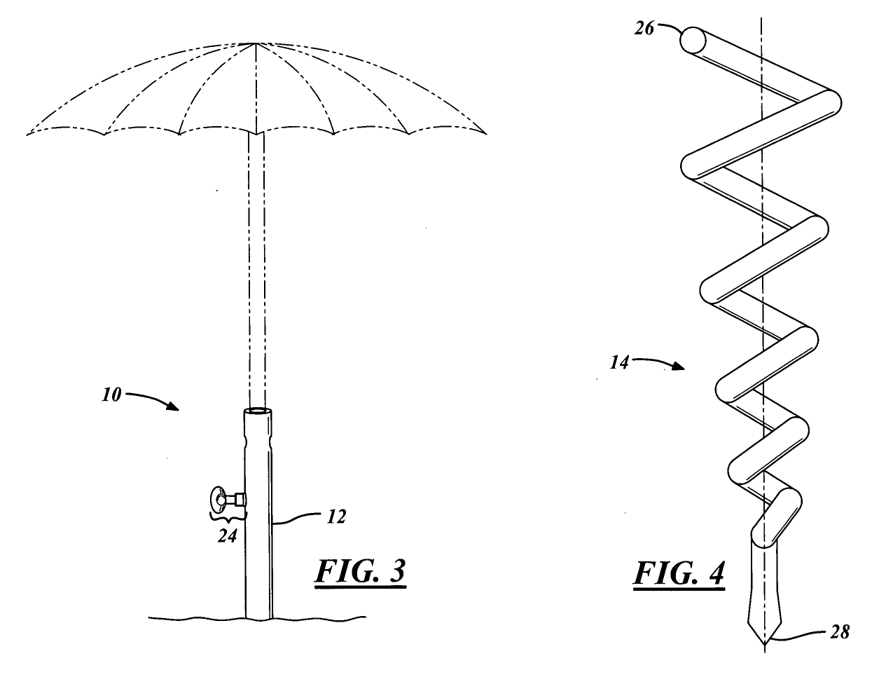

Support 10 may further include a nut and handwheel assembly 24 configured for tightening the support. The nut of assembly 24 is coupled to tube 12, and in an exemplary embodiment, the nut may be welded into an aperture of tube 12. The handwheel of assembly 24 is a knob with a shaft. The shaft of the handwheel may be screwed into the nut. The handwheel may be turned so that the end of the shaft is adjusted to engage any equipment disposed within tube 12. In an exemplary embodiment best shown in FIG. 3, the handwheel may be turned so that the shaft that is screwed into the nut engages, for example only, the pole of an umbrella disposed within tube 12. Adjustment of the handwheel ensures that the umbrella is securely disposed within tube 12 and reduces movement of the umbrella within tube 12. It is understood that while an umbrella is described in detail, one of ordinary skill in the art may utilize the invention with any of various other types of equipment and remain within the spirit and scope of the invention. It is further understood that an umbrella is not part of the invention and is shown only for illustrative purposes, so that handwheel and nut assembly 24 may be explained in greater detail.

Coil 14 is provided for penetrating the ground during insertion of support 10 into the ground. Coil 14 has a screw (helical) arrangement to thereby draw tube 12 into the ground, much like the thread of a threaded wood fastener drawn into the wood. Coil 14 is open (i.e., threads minus the shaft), thereby decreasing the amount of earth that must be displaced into the adjacent ground during insertion of support 10. In an exemplary embodiment, a majority of the length of coil 14 is open. Coil 14 may comprise wire rod or rebar in an exemplary embodiment. Coil 14 may be approximately 30″ (762 mm) long when uncoiled and approximately ⅜″ (10 mm) in diameter. When coiled, coil 14 may be approximately 8″ (203 mm) long. In an exemplary embodiment, when coil 14 is coiled into shape, it may be shorter in length than tube 12. It is understood that while these dimensions are described in detail, one of ordinary skill in the art may alter the dimensions of coil 14 and remain within the spirit and scope of the invention. Coil 14 includes a first end 26 and second end 28.

First end 26 of coil 14 is coupled to bottom open end 16 of tube 12. In an exemplary embodiment, first end 26 may be welded to bottom open end 16 of tube 12. It should be understood that other conventional attachment methods are within the spirit and scope of the invention.

Coil 14 is shaped so that a diameter of first end 26 is greater than a diameter of second end 28. In an exemplary embodiment, the shape is a taper where the diameter of first end 26 may be between approximately 1.5 and 3 times greater than a diameter of second end 28. An inner diameter of first end 26 may be approximately equal to the outer diameter of tube 12. In an exemplary embodiment where the outer diameter of tube 12 is approximately 1 ¾″ (44 mm) in diameter, the inner diameter of first end 26 may be approximately 1¾″ (44 mm) in diameter. As best viewed in FIG. 4, each segment of coil 14 comprising a complete circle of 360° may remain the same length or decrease in length moving from first end 26 to second end 28. In an exemplary embodiment, a first and second segment may each be approximately 2″ (51 mm) in length, a third segment may be approximately 1½″ (41 mm) in length, a fourth segment may be approximately 1¼″ (33 mm) in length, and a fifth segment may be approximately 1″ (25 mm) in length. As best viewed in FIG. 4, the diameter of first end 26 of coil 14 may be approximately 1¾″ (44 mm), while the diameter of the top portion of the fifth segment of coil 24 may be approximately 1″ (25 mm). It is understood that while these dimensions are described in detail, one of ordinary skill in the art may alter the dimensions of coil 14 and remain within the spirit and scope of the invention, so long as coil 14 reduces in diameter from top end 26 to bottom end 28.

Referring now to FIGS. 1 and 4, second end 28 is configured for insertion into the ground. Second end 28 may be tapered to an approximate center point of coil 14. Second end 28 may be thin or flat with a pointed tip to aid in the penetration of coil 14 into the ground. As best viewed in FIG. 4, second end 28 is approximately ½″ (13 mm) in width and approximately 1¾″ (44 mm) in length. It is understood that while these dimensions are described in detail, one of ordinary skill in the art may alter the dimensions of coil 14 and remain within the spirit and scope of the invention. In an alternative embodiment, second end 28 of coil 14 may be cut at a 45° angle to form a pointed tip.

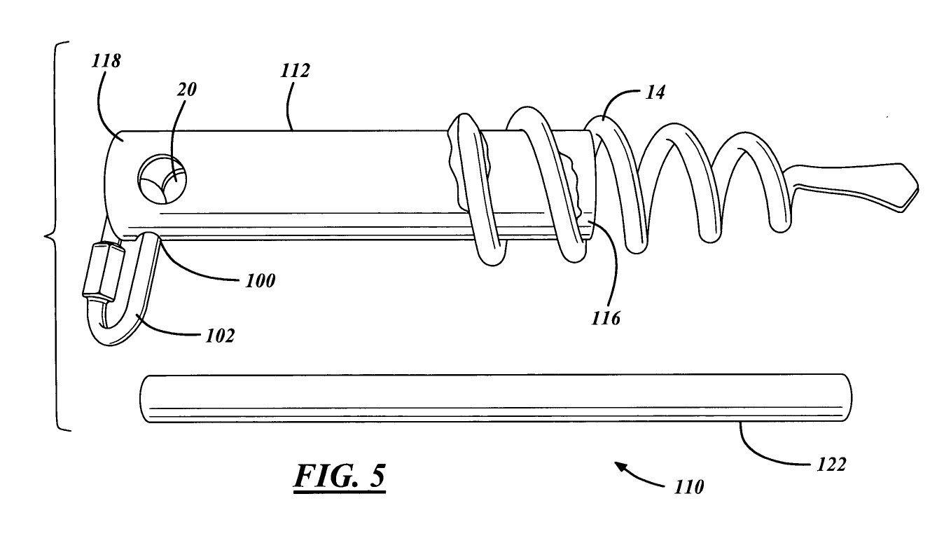

Referring now to FIG. 5, a portable support 110 in accordance with a second embodiment of the present invention is illustrated. Support 110 is configured for manual insertion into the ground to a sufficient depth to serve as a land aircraft tie down or as a tie down for any of various other objects. Support 110 may be substantially identical to support 10 with the following exceptions. First, tube 112 of support 110 may be shorter than tube 12 of support 10. In an exemplary embodiment, tube 112 may be approximately 8″ (203 mm) long. Second, handle 122 of support 110 may be shorter than handle 22 of support 10. In an exemplary embodiment, handle 122 may be approximately 11½″ (292 mm) long. Third, while tube 112 retains aligned and diametrically opposite apertures 20, it also includes a third aperture 100. Fourth, support 110 may not include a nut and handwheel assembly 24, but may include a fastener 102.

Aperture 100 of support 110 is provided for retaining fastener 102. Aperture 100 is disposed near top end 118 of tube 112. Aperture 100 is offset from the aligned and diametrically opposite apertures 20.

Fastener 102 of support 110 is provided for serving as a point of attachment for a land aircraft, for example, or any of various other objects. It is understood that while land aircraft is described in detail, one of ordinary skill in the art may utilize the invention with any of various other equipment and objects and remain within the spirit and scope of the invention. Fastener 102 may comprise a generally C-shaped clip that may be configured to be opened and closed. Fastener 102 may comprise galvanized steel.

Portable supports 10 and 110 in accordance with the present invention represent an improvement as compared to conventional portable supports. First, the tapered end of coil 14 of portable supports 10 and 110 more efficiently penetrates the ground and increases the depth to which portable supports 10 and 110 may be inserted into the ground for improved support and strength. This increased depth increases the withdrawal force required to remove supports 10 and 110 in a non-rotational manner (i.e., axially straight out). Second, coil 14 is open so as to decrease the amount of earth that is displaced during insertion of portable supports 10 and 110 into the ground. Third, bottom ends 16 and 116 of tubes 12 and 112 are open to both decrease the amount of earth that is displaced during insertion of portable supports 10 and 110 into the ground and further to stabilize portable supports 10 and 110 by allowing earth to flow up into tubes 12 and 112 during insertion of portable supports 10 and 110 into the ground. Fourth, the inventive supports 10 and 110 are relatively lightweight (owing to the hollow tube/handle and open coil) and of relatively small size, improving the portability of the support device. In exemplary embodiments, support 10 may weigh only approximately 3¾ pounds (1.7 kg) and support 110 may weigh only approximately 2¼ pounds (1 kg). It is understood that while these weights are described in detail, one of ordinary skill in the art may alter the weight of portable supports 10 and 110 and remain within the spirit and scope of the invention.

While the invention has been shown and described with reference to one or more particular embodiments thereof, it will be understood by those of skill in the art that various changes and modifications can be made without departing from the spirit and scope of the invention.

1. A portable support for insertion into the ground, comprising:
a tube with an open end; and
an open coil with a first end coupled to said open end of said tube and a second end for insertion into said ground, wherein said coil is shaped so that a diameter of said first end of said coil is greater than a diameter of said second end of said coil.

2. The portable support of claim 1, wherein said coil is tapered.

3. The portable support of claim 1, wherein said tube comprises steel.

4. The portable support of claim 1, wherein said coil comprises a wire rod.

5. The portable support of claim 1, wherein said coil comprises rebar.

6. The portable support of claim 1, wherein said coil may be shorter in length than said tube.

7. The portable support of claim 1, wherein an inner diameter of said first end of said coil is approximately equal to an outer diameter of said open end of said tube.

8. The portable support of claim 1, wherein said open coil is coupled to said open end of said tube by welding.

9. The portable support of claim 1, wherein said open coil is tapered at said second end to an approximate center point of said coil.

10. The portable support of claim 9, wherein said second end of said open coil is pointed.

11. The portable support of claim 1, wherein said tube includes aligned and diametrically opposite apertures.

12. The portable support of claim 11, wherein said apertures are disposed toward an end of said tube.

13. The portable support of claim 11, further comprising a handle.

14. The portable support of claim 13, wherein said handle comprises a tube.

15. The portable support of claim 13, wherein said handle comprises steel.

16. The portable support of claim 13, wherein said apertures are configured to receive said handle.

17. The portable support of claim 13, wherein a diameter of said handle is smaller than a diameter of said tube.

18. The portable support of claim 1, further comprising a handwheel and nut assembly for tightening said support.

19. The portable support of claim 1, wherein a majority of the length of said coil is open.

20. The portable support of claim 1, wherein said diameter of said first end of said coil is between approximately 1.5 and 3 times greater than said diameter of said second end of said coil.
